(19) United States
(12) Patent Application Publication
(10) Pub. No.: US 2007/0191540 A1
(43) Pub. Date: Aug. 16, 2007

(54) LOW DIELECTRIC LOSS RESIN, RESIN COMPOSITION, AND THE MANUFACTURING METHOD OF LOW DIELECTRIC LOSS RESIN

(76) Inventors: Jun Nunoshige, Tokyo (JP); Mitsuru Ueda, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/623,785

(22) Filed: Jan. 17, 2007

(30) Foreign Application Priority Data
Feb. 13, 2006 (JP) 2006-034935

(51) Int. Cl. C08L 69/00

(52) U.S. Cl. 524/611

(57) ABSTRACT

An object of the present invention is to provide a low dielectric loss resin composition with a narrow molecular weight distribution, the resin composition suffering as low a dielectric loss as that of commercially available polyphenylenether, being soluble in a general-purpose solvent with a low boiling point, and being easily processed into a wiring board. The present invention provides a thermosetting low dielectric loss resin which is a random copolymer of polyphenylenether having an unsaturated bond in a side chain and which has a molecular weight distribution of less than 10, more preferably at most 5, particularly preferably at most 3, as well as the hardened resin, a resin composition and an electronic part containing the resin, and a synthesizing method for obtaining the resin.

### BACKGROUND OF THE INVENTION

The present invention relates to a low dielectric loss resin that is suitably used as a high-frequency mounting material, a resin composition containing the low dielectric loss resin, and a method for manufacturing the low dielectric loss resin.

In recent years, the signal bands of information communication equipment such as PHSs and cellular phones have been extended. Most computers offer a CPU clock time of the order of GHz. Further effort has been made to increase the frequency.

The transmission loss of electric signals is proportional to the product of dielectric loss tangent and frequency. The transmission loss increases consistently with the frequency of signals used. The increased transmission loss attenuates signals to degrade their reliability. Further, the signal transmission loss is converted into heat, resulting in a disadvantageous increase in temperature. Thus, insulating materials with very low dielectric loss tangents are strongly desirable for high frequency regions.

To reduce the dielectric loss tangent (dielectric loss) of an insulating material, an acidic group can be effectively removed from a molecular structure. Many structures have been proposed, including a fluorine resin, hardening polyolefin, a cyanatester-containing resin, hardening polyphenylenether, and polyetherimide modified by divinylbenzene, or divinylnaphthalene. However, the fluorine resin is generally thermoplastic and is limited in the ability to form multilayered structures. Further, the fluorine resin does not solve in general-purpose solvents. A high-temperature and -pressure process is thus required to manufacture wiring boards using the fluorine resin. The hardening polyolefin has excellent dielectric characteristics but does not offer a sufficient heat resistance. The cynatester and polyetherimide are excellent in heat resistance but is limited in dielectric characteristics.

In contrast, the hardening polyphenylene has been developed as a material that is excellent both in heat resistance and in dielectric characteristics. For example, JP-A-5-306366 and JP-A-2003-155340 have been published. However, a hardening PPE resin described in JP-A-5-306366 has halogen remaining in part of the structure, resulting in a greater dielectric loss than ordinary PPE. Further, JP-A-2003-155340 states a bisphenol low-molecular-weight oligomer improves solubility and moldability. However, the molecular weight needs to be increased in order to reduce the dielectric loss, while increasing heat resistance.

The polyphenylenether does not substantially solve in common general-purpose solvents with low boiling points. Chloroform (halogen-containing solvent), hot toluene, or the like is thus required to form the polyphenylenether into varnish in a process of manufacturing wiring boards. This is disadvantageous for environments and safety.

T. Fukuhara, Y, Shibasaki, S. Ando, M. Ueda. Polymer, 45 (2004) attempts to modify the polyphenylenether by forming the polyphenyenether into a copolymer containing an unsaturated bond in part of its side chain. Modifying the side chain results in a thermosetting resin having a wide molecular weight distribution (Mw/Mn>10). This resin thus suffers a greater dielectric loss than commercially available polyphenylenether.

Public Report of the Precision Polymer Project for 2003 and 2004—Research and Development of High-Function Materials increases the purity of the resin to enable a reduction in impurities; the purification enables a reduction in dielectric loss. However, the resin resulting from polymerization has a wide molecular weight distribution. Accordingly, the purification enables the molecular weight and the molecular weight distribution to be set but reduces yield. Thus, this method is not preferable as a method for obtaining a low-dielectric-loss material.

### SUMMARY OF THE INVENTION

An object of the present invention is to provide a low dielectric loss resin having a narrow molecular weight distribution, the resin suffering as low a dielectric loss as commercially available polyphenylenether resins, being soluble in general-purpose solvents with low boiling points at room temperature, and being easily processed into wiring boards.

The present inventors examined thermosetting polyphenylenether resins with their molecular weight distributions pre-limited by polymerization as well as related polymerizing methods, which are different from the methods described above.

The present invention provides a thermosetting low dielectric loss resin which is a random copolymer consisting of repeating units expressed by Formula (1) and which is obtained by a polymerization reaction and has a molecular weight distribution of less than 10, more preferably, at most 5, particularly preferably at most 3, as well as the hardened resin and a resin composition and an electronic part containing the resin. The present invention also provides a synthesizing method for obtaining the resin.

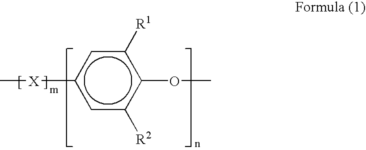

In the formula, X denotes a repeating unit expressed by Formula (2), R¹ and R² denote hydrocarbon groups with a carbon number of 1, R³ denotes a functional group containing an unsaturated hydrocarbon with a carbon number of 2 to 9, R⁴ denotes a functional group containing at least one of a saturated hydrocarbon, an unsaturated hydrocarbon, and an aromatic hydrocarbon, and m and n denote integers of at least 2 which indicate the degrees of polymerization.

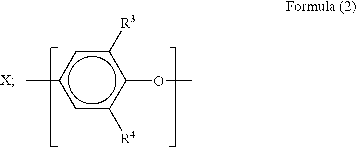

The random copolymer is a cross-linker. The term “cross-linker” as used herein refers to the random copolymer in accordance with the present invention and is used to distinguish it from well-known cross-linkers such as 1,3,5-triarylisocyanate.

An object of the present invention is to control the molecular weight distribution of polyphenylenether containing an unsaturated bond (aryl group) in its side chain (hereinafter simply referred to as a PPE copolymer) to provide a thermosetting PPE copolymer which has a low dielectric loss, is easily soluble, and has an advanced cross linking capability. The resin obtained is characterized by maintaining a low dielectric characteristic comparable to that of poly-(2,6-dimethylphenyleneether) (hereinafter simply referred to as PPE).

The present invention can thus provide low dielectric loss resin having a narrow molecular weight distribution, the resin suffering as low a dielectric loss as commercially available polyphenylenether resin, being soluble in general-purpose solvents with low boiling points at room temperature, and being easily processed into wiring boards.

Other objects, features and advantages of the invention will become apparent from the following description of the embodiments of the invention taken in conjunction with the accompanying drawings.

### BRIEF DESCRIPTION OF THE DRAWINGS

FIG. 1 is a graph showing TMA•SS measurements of hardened resins and hardened resin compositions in accordance with examples of the present invention;

FIG. 2 is a graph showing the glass transition temperatures of resin compositions in accordance with examples of the present invention;

FIG. 3 is a graph showing the pyridine ration and molecular weight distribution of the resin component in accordance with examples of the present invention;

FIG. 4 is a diagram showing an example of structure of a conventional high-frequency semiconductor device;

FIG. 5 is a diagram showing an example of structure of a high-frequency semiconductor device in accordance with examples of the present invention;

FIGS. 6(A) to 6(E) are diagrams showing an example of production of a multilayer wiring board in accordance with an example of the present invention;

FIGS. 7(A) to 7(G) are diagrams showing an example of production of a multilayer wiring board in accordance with another example of the present invention;

FIGS. 8(A) to 8(I) are diagrams showing yet an example of production of a multilayer wiring board in accordance with yet another example of the present invention;

FIGS. 9(A) to 9(F) are diagrams showing an example of production of a multilayer wiring board in accordance with an example of the present invention; and

FIG. 10 is a sectional view showing an antenna element-integrated high-frequency module in accordance with an example of the present invention.

### DESCRIPTION OF REFERENCE NUMERALS

1 material
2 concave parts
3 semiconductor chip
4 cover
5 sealing material
6 terminal
7 wiring
8 low dielectric constant layer
9 lead frame
10 prepreg
11 conductor foils
13 laminate
14 through-hole
15 plating film
16 conductor wires
17 insulating layer
18 external connection terminal
19 board
20 high-frequency circuit module
21 discrete parts
22, 23 dielectric layer
24 antenna element
25 ground electrode
26 wires
27, 28 vie hole
29 jumper wire

### DETAILED DESCRIPTION OF THE INVENTION

T. Fukuhara, Y, Shibasaki, S. Ando, M. Ueda. Polymer, 45 (2004) discloses a thermosetting aryl PPE copolymer. However, this resin has a wide molecular weight distribution (Mw/Mn>10) and thus suffers a greater dielectric loss than PPE. This is probably due to the generation of a branch structure resulting from the presence of a low-molecular-weight substance in the polymerizing process, the reaction between the aryl group and part of a growth radical generated during oxidation coupling polymerization, a chain transfer reaction, or the like. This also induces the molecular motion of the side chain, sharply increasing the dielectric loss of the resin. A similar phenomenon occurs in other thermosetting PPE copolymers with unsaturated bonds. Accordingly, the present inventors examined resins obtained by the oxidation coupling reaction in order to find a low dielectric loss resin having a narrow molecular weight distribution (Mw/Mn<10); the present inventors also examined methods for obtaining such a low dielectric loss resin. Narrowing the molecular weight distribution makes it possible to reduce the end groups of the resin to minimize the molecular motion at a high frequency.

JP-A-2003-155340 discloses the resin modified using the end hydroxyl group of the PPE oligomer. This resin cannot unitarily offer a sufficient mechanical strength owing to the nature of the oligomer and the small number of thermosetting groups compared to the number of main chains. To offer a sufficient mechanical strength, an unsaturated hydrocarbon is desirably contained in the resin structure as in the present invention.

Further, introducing a massive group in part of the side chain improves solubility. Thus, the solubility of the PPE is improved by adding an aryl group or the like which contains an unsaturated bond to the side chain. However, solubility is low in a non-halogen-containing solvent than in a halogen-containing solvent. Thus, a resin with a greater molecular weight is less soluble in a non-halogen-containing resin, resulting in insoluble portions in the solution. Thus, with a non-halogen-containing solvent, the three-dimensional structure of the side chain is taken into account so that the molecular weight does not serve to reduce the solubility of the structural resin.

Thus, the present inventors examined a method for manufacturing a thermosetting PPE polymer having a reduced molecular weight distribution of less than 10 (Mw/Mn<10), more preferably at most 5 (Mw/Mn<5), particularly preferably at most 3 (Mw/Mn<3) through oxidation coupling polymerization, a low dielectric loss resin consisting of the thermosetting PPE copolymer, and a resin composition containing the low dielectric loss resin. The new thermosetting PPE copolymer exhibiting the above performance offers more excellent dielectric characteristics, is more easily soluble, and resists heat more properly than the conventional modified polyphenylenether.

The present invention provides a method for manufacturing a low dielectric loss resin for a multilayer wiring board which is a copolymer comprising repeating units expressed by Formula (1). The oxidation coupling polymerizing method is used for the copolymer expressed by Formula (1).

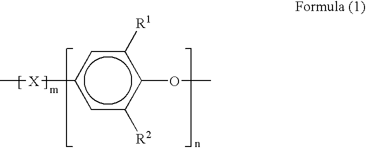

In the formula, X denotes a repeating unit expressed by Formula 2, R¹ and R² denote hydrocarbon groups with a carbon number of 1, R³ denotes a functional group containing an unsaturated hydrocarbon with a carbon number of 2 to 9, R⁴ denotes a functional group containing at least one of a saturated hydrocarbon, an unsaturated hydrocarbon, and an aromatic hydrocarbon, and m and n denote integers of at least 2 which indicate the degrees of polymerization.

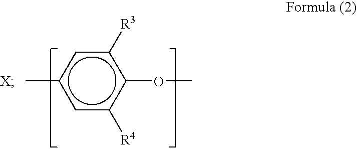

This copolymer resin has a molecular weight distribution of less than 10 (Mw/Mn<10), more preferably at most 5 (Mw/Mn≦5), particularly preferably at most 3 (Mw/Mn≦3). The unhardened copolymer resin preferably has a glass transition temperature of 210° C. The copolymer resin or a hardened resin composition containing the copolymer resin preferably has a dielectric loss tangent of at most 0.003.

The method for subjecting the resin to oxidation coupling polymerization can be properly carried out by taking into account the rate of a polymerization catalyst in a reaction system. That is, conventional PPE oxidation coupling polymerization uses a mixture of copper chloride (I) and pyridine as a catalyst. Thus, the molecular weight distribution of the resin can be reduced by extremely reducing the rate of copper chloride (I) compared to that specified in the conventional synthesis conditions.

A specific method will be described below. First, the molar ratio of monomer to copper chloride was set to at least 60, more preferably at least 80. The molar ratio is about 6 to 8 under the conventional conditions. Thus, by carrying out synthesis so that the amount of the monomer component is extremely larger than that of the copper chloride component, it is possible to suppress possible secondary reactions of oxidation coupling polymerization to obtain a resin with a narrow molecular weight distribution.

The molar ratio of amine ligand such as pyridine to copper chloride (I) was set to at least 300, more preferably at least 600, much more preferably at least 1,000. The molar ratio is about 100 under the conventional conditions. Extremely increasing the rate of the amine ligand improved the effect of suppressing possible secondary reactions. The resin obtained has a narrower molecular weight distribution. Even a resin with a number average molecular weight of at least 20,000 can be easily polymerized into a resin with a very narrow molecular weight distribution. Example 6 describes polymerization conditions in detail. The effect of suppressing the molecular weight distribution is significant for resins having at least one unsaturated hydrocarbon in the structure shown in Formula (1).

A known purifying process is executed on the resin obtained in accordance with the present invention to remove impurities from the resin. This is expected to further reduce the dielectric loss of the resin. A specific example of a purifying method described in Public Report of the Precision Polymer Project for 2003 and 2004—Research and Development of High-Function Materials. When the resin obtained in accordance with the present invention has a narrow molecular weight distribution with a number average molecular weight of at most 50,000, the yield is unlikely to decrease in spite of the purifying process. The rights of the present invention are not limited by the method of the purifying process.

Conventional techniques are used for the low dielectric loss resin in accordance with the present invention. Typical solvents used include halogen-containing compounds and aromatic hydrocarbon-containing compounds. However, the present invention is not limited to these compounds. Examples of the halogen-containing compound include dichloromethane, chloroform, and methyl tetrachloride. Examples of the aromatic hydrocarbon include toluene and xylene. Varnish can be produced by dissolving or uniformly dispersing a copolymer in these solvents.

The PPE resin is known to be soluble in the halogen-containing solvent, described above. In view of burdens on environments and the toxicity of the solvent, the halogen-containing solvent is considered to impose greater burdens on the environments than hydrocarbon-containing solvents. Thus, the resin is more preferably easy to handle with non-halogen-containing solvents containing no halogen.

At least 10 wt %, more preferably at least 20 wt % of the low dielectric loss resin obtained in accordance with the present invention is soluble in a non-halogen-containing organic solvent with a boiling point of at most 150° C., at room temperature. Consequently, a resin composition is provided which contains a non-halogen-containing organic solvent with a boiling point of at most 150° C. and the low dielectric loss resin in the organic solvent. The resin composition may contain a coloring agent, a radical initiator, a cross-linker, or the like as required.

To produce varnish, it is possible to dissolve or uniformly disperse a predetermined amount of the copolymer in accordance with the present invention in the solvent and to add a second component and a third component to the solution as required. To promote the cross linking of a thermoset resin, it is possible to add a cross linking catalyst or promoter to the solution. Examples of the cross linking catalyst that cross-links an unsaturated bond include cation and a radical active species. It is also possible to add a filler, a coloring agent, a fire retardant, an adhesive agent, a coupling agent, a defoaming agent, a leveling agent, an ion trapper, a polymerization inhibitor, an antioxidant, or a viscosity modifier as required.

To be actually applied to a multilayer wiring board, the resin in accordance with the present invention is dissolved into an organic solvent to prepare varnish. A fiber base such as a glass cloth is impregnated with the varnish. The fiber base is then dried to produce a prepreg. The resin in accordance with the present invention is thermosetting and is thus thermally hardened. The unhardened resin is soluble in the solvent to allow varnish to be prepared. The varnish can be used to produce a prepreg. The prepreg is obtained by impregnating a base such as a glass cloth with varnish and then drying the base. The prepreg is then laminated to a wiring layer in a well-known manner to produce a multilayer wiring board.

The present invention embraces an electric part having an insulating layer in which various insulating materials with different dielectric constants are dispersed in the cross linking component. This configuration enables the dielectric constant to be easily adjusted while inhibiting an increase in the dielectric loss tangent of the insulating layer. The resin composition in accordance with the present invention allows the dielectric constant to be adjusted to within the range of about 2.3 to 3.0 at 1 GHz according to the type of a high molecular weight substance to be blended and the amount of the substance to be added. For a high-frequency electric part having a low-dielectric-constant insulator with a dielectric constant of about 1.0 to 2.2 at 1 GHz dispersed in the insulating layer, the dielectric constant of the insulating layer can be adjusted to about 1.5 to 2.2.

The use of the polyphenylenether copolymer in accordance with the present invention provides a resin composition which maintains the low dielectric loss characteristic and which properly resists heat. The resin composition is also soluble in a non-halogen-based organic solvent with a boiling point of at most 150° C. A wiring board using the resin composition as a matrix resin for the insulating layer can be processed and molded as easily and properly as conventional wiring boards made of an epoxy resin or the like. For electrical characteristics, this wiring board has a much smaller dielectric loss than the conventional epoxy wiring board. This wiring board has also been confirmed to offer as excellent thermal characteristics as or more excellent thermal characteristics than the conventional epoxy wiring board; the thermal characteristics are typified by solder heat resistance.

A typical example of polyphenylenether is a 2,6-dimethylphenol polymer (poly-2,6-dimethylphenol). This resin exhibits an excellent dielectric characteristic value but is thermosetting and has a boiling point of about 200° C. A wiring board using this resin may have its insulating layer deformed or fluidized during a reflow step (up to about 260° C.) of a parts mounting process. The heat resistance of this wiring board is improper. Further, the wiring board needs to offer a sufficient mechanical strength (toughness) and desirably has a molecular weight of at least 10,000. A lower molecular weight makes it difficult to provide the resin with a sufficient strength. However, a 2,6-dimethylphenol polymer of molecular weight at least 10,000 is not easily soluble in the solvent. This requires the need to use a solvent such as chloroform (halogen-containing solvent) or hot toluene (at least 50° C.) which is difficult to handle. It is difficult to apply non-halogen-containing organic solvents with a boiling point of at most 150° C. which are commonly used to produce conventional boards.

According to the present invention, in the copolymer structure, R¹ and R² denote hydrocarbon groups with a carbon number of 1, R³ denotes a functional group containing an unsaturated hydrocarbon preferably having a carbon number of 2 to 9, and R⁴ denotes a functional group containing a saturated hydrocarbon, or an unsaturated hydrocarbon preferably having a carbon number of 2 to 9. The present invention can thus provide a material which offers a high thermal resistance and which is easily soluble.

A specific example of the functional group containing the unsaturated hydrocarbon is a substituent group having an unsaturated bond in any of various hydrocarbon groups with a carbon number of 2 to 9, such as a vinyl group, an aryl group, an isopropenyl group, a butyl group, isobutenyl group, and a pentenyl group. These unsaturated bonds cause a cross liking reaction under heat, contributing to the improved heat resistance of the wiring board. This makes it possible to inhibit the insulating layer in the wiring board from being deformed or fluidized during the reflow step (up to about 260° C.) of the parts mounting process. Introducing a substituent group having a longer molecular chain than a methyl group allows the resin to solve more properly in the solvent.

Specific examples of the functional group containing the aromatic hydrocarbon include a phenyl group, a tolyl group, a xylyl group, a cumenyl group, a mesityl group, a benzyl group, a phenetyl group, a styryl group, and a styryl methyl group. Introducing any of these aromatic hydrocarbon groups improves the heat resistance of the copolymer. The substituent group is also effective in improving the solubility in the solvent.

Specific examples of the copolymer used in the present invention include the following substances. A copolymer of (2,6-dimethylphenylether) and (2-vinyl-6-methylphenylether), a copolymer of (2,6-dimethylphenylether) and (2-vinyl-6-styrylphenylether), a copolymer of (2,6-dimethylphenylether) and (2-aryl-6-methylphenylether), a copolymer of (2,6-dimethylphenylether) and (2-aryl-6-phenylphenylether), a copolymer of (2,6-dimethylphenylether) and (2-aryl-6-phenylphenylether), a copolymer of (2,6-dimethylphenylether) and (2-aryl-6-styrylphenylether), a copolymer of (2,6-dimethylphenylether) and (2,6-divinylphenylether), a copolymer of (2,6-dimethylphenylether) and (2,6-diarylphenylether), a copolymer of (2,6-dimethylphenylether) and (2,6-diisopropenylphenylether), a copolymer of (2,6-dimethylphenylether) and (2,6-dibutenylphenylether), a copolymer of (2,6-dimethylphenylether) and (2,6-diisobutenylphenylether), a copolymer of (2,6-dimethylphenylether) and (2,6-dipentenylphenylether), a polymer of (2,6-dimethylphenylether) and (2,6-diisopentenylphenylether), a copolymer of (2,6-dimethylphenylether) and (2,6-dinonenylphenylether), a copolymer of (2,6-dimethylphenylether) and (2,6-distyrylether), a copolymer of (2,6-dimethylphenylether) and (2,6-distyrylmethylether), a copolymer of (2,6-dimethylphenylether) and (2-methyl-6-styrylether), and a copolymer of (2,6-dimethylphenylether) and (2-methyl-6-distyrylmethylether).

To produce varnish, it is possible to dissolve or uniformly disperse a predetermined amount of the copolymer in accordance with the present invention in the solvent and to add a second component and a third component to the solution as required. To promote the cross linking of a thermoset resin, it is possible to add a cross linking catalyst or cross-linker to the solution. The amount of the agent added is not particularly limited but is preferably 0.01 to 5 parts by weight, more preferably 0.01 to 1 parts by weight, much more preferably 0.01 to 0.5 parts by weight relative to the 100 parts by weight of the copolymer.

5 to 10 parts by weight of cross linking agent or cross-linker is added to an unhardened conventional PPE thermoset resin and its resin composition. However, the resin in accordance with the present invention hardens more efficiently than the conventional resin composition because of an unsaturated hydrocarbon group contained in its structure which is obtained by random copolymerization. Thus, the resin in accordance with the present invention can be sufficiently hardened even with a small amount of cross linking agent or cross-linker.

Further, the addition of too much catalyst increases the dielectric loss to affect the electrical characteristics. On the other hand, the addition of too little catalyst makes the promotion effect insufficient, but particularly for resins with a vinyl group or an aryl group in their side chain, even a small amount of additive was effective for promotion. Owing to the effect of the additive, the cross linking catalyst promotes a cross linking reaction at low temperatures. The cross-linker increases cross linking density. This enables the production of a heat-resistant insulating material.

As the cross linking catalyst for the unsaturated bond, examples of cation and a radical active species are shown below. Examples of the cation catalyst include a diaryliodonium salt, a triarylsulfonium salt, and an aliphatic sulfonium salt for which BF4-, PF6-, AsF6-, or SbF6- is used as a counter anion. Examples of the radical catalyst include benzoin-containing compounds typified by benzoin and bezoinmethyl, acetophenone-containing compounds typified by acetophenone and 2,2-dimethoxy-2-phenylacetophenone, thioxanthone-containing compounds typified by thioxanthone and 2,4′-diethylthioxanthone, bisazido compounds typified by 4,4′-diazidochalcone, 2,6-bis(4′-azidobenzal) cyclohexane, and 4,4′-diazidobenzophenone, azo compounds such as azobisisobutyronitrile, 2,2-azobispropane, m, m′-azoxystyrene, and hydrazine, and organic peroxides such as 2,5-dimethyl-2,5-(t-butylperoxy) hexane-3,2,5-dimethyl-2,5-(t-butylperoxy)hexane, dicumylperoxide, and benzoilperoxide.

Examples of the cross linking agent include 1,3,5-triarylisocyanurate (TAIC), trylamine, and triarylcyanurate.

It is also possible to add a filler, a coloring agent, a fire retardant, an adhesive agent, a coupling agent, a defoaming agent, a leveling agent, an ion trapper, a polymerization inhibitor, an antioxidant, or a viscosity modifier as required.

Two methods are available for manufacturing a wiring board. One of them involves impregnating a reinforcing material with varnish to produce a prepreg. The other involves coating the resin directly on a copper foil or the like to form an insulating layer for a substrate which contains only the resin and no reinforcing material. Many rigid boards on which a large number of parts are mounted use reinforcing materials. However, the present invention is not particularly limited in this regard. Further, many flexible boards and buildup boards use no reinforcing material. The reinforcing material may be a woven cloth, a nonwoven cloth, woven paper, a film, or the like, which is commonly used as a wiring board. Typical examples of the reinforcing material include inorganic oxides such as E glass, S glass, D glass, NE glass, silica glass, and A glass, and organic substances such as polyimide and polyaramide.

The present invention disperses a high molecular weight substance in an insulating layer to make the insulating layer stronger and allow it to elongate sufficiently, adhere adequately to conductor wiring, and to properly form a film. This makes it possible to produce a prepreg required to make a multilayer wiring board and a laminate with a conductor film (hereinafter referred to as a laminate) obtained by laminating the conductor film and the prepreg to each other and hardening the laminate. A high-density multilayer wiring board can also be produced by a thin-film forming process. The high molecular weight substance preferably has a number average molecular weight of 5,000 to 50,000, more preferably 10,000 to 40,000. Too small a molecular weight may result in an insufficient increase in mechanical strength. Too great a molecular weight may result in excessively viscous varnish formed of a resin composition, which makes mixed agitation and film formation difficult. Examples of the high molecular weight substance include a monomer and their polymers selected from the group consisting of butadiene, isoprene, styrene, ethylstyrene, divinylbenzene, N-vinylphenylmaleimide, acrylic ester, and acrylonitrile, and polyphenylenether oxide, cyclic polyolefin, polysiloxane, and polyetherimide which may have a substituent group. Among them, the polyphenylene oxide and cyclic polyolefin are preferable because of their high strengths and low dielectric loss tangents.

To actually apply the resin in accordance with the present invention to a multilayer wiring board, the resin is dissolved into an organic solvent to prepare varnish. Then, a fiber base such as a glass cloth is impregnated with the varnish and then dried to produce a prepreg. Formula (1), (2), and/or (3), shown above, results in a low dielectric loss resin for a multilayer wiring board which is a thermoplastic resin if R¹ to R⁸ have no unsaturated bond.

Formula (1), (2), and/or (3) results in a low dielectric loss resin for a multilayer wiring board which is a thermoplastic resin if at least one of R¹ to R⁸ has an unsaturated bond. The unhardened thermosetting resin is soluble in the solvent to allow varnish to be prepared. The varnish can be used to make a prepreg. The prepreg is produced by impregnating a base such as a glass cloth with the varnish and then drying the base. The prepreg is then laminated to a wiring layer by a well-known method to make a multilayer wiring board.

The present invention embraces an electric part having an insulating layer in which various insulating materials with different dielectric constants are dispersed in the cross linking component. This configuration enables the dielectric constant to be easily adjusted while inhibiting an increase in the dielectric loss tangent of the insulating layer. The resin composition in accordance with the present invention allows the dielectric constant to be adjusted to within the range of about 2.3 to 3.0 at 1 GHz according to the type of a high molecular weight substance to be blended and the amount of the substance to be added. For a high-frequency electric part having a low-dielectric-constant insulator with a dielectric constant of about 1.0 to 2.2 at 1 GHz dispersed in the insulating layer, the dielectric constant of the insulating layer can be adjusted to about 1.5 to 2.2.

Reducing the dielectric constant of the insulating layer enables electric signals to be transmitted at higher speeds. This is because the transmission speed of electric signals is proportional to the reciprocal of square root of the dielectric constant; the transmission speed increases with decreasing dielectric constant of the insulating layer. The preferable low-dielectric-constant insulator is low-dielectric-constant resin particles, empty resin particles, empty glass balloons, or a void (air). The preferable low-dielectric-constant insulator has an average particle size of 0.1 to 100 μm, more preferably 0.2 to 60 μm in terms of the strength and insulating reliability of the insulating layer. Examples of the low-dielectric-constant resin particles include polytetrafluoroethylene particles and polystyrene-divinylbenzene cross linking particles. Examples of the empty particles include empty styrene-divinylbenzene cross linking particles, silica balloons, glass balloons, and sirasu balloons. The low-dielectric-constant insulating layer can be suitably used as a sealing resin for semiconductor devices that need to transfer signals at high speed or wiring for MCM boards or the like which electrically connects chips together and for the formation of circuits such as high-frequency chip inductors.

On the other hand, the present invention disperses an insulator having a high dielectric constant of 3.0 to 10.0 at 1 GHz in the insulating layer to allow the production of a high-frequency electric part having an insulating layer with a high dielectric constant of 3.1 to 20 and which can inhibit an increase in dielectric loss tangent. Increasing the dielectric constant of the insulating layer makes it possible to reduce the size of the circuit while increasing the capacitance of a capacitor, contributing to the size reduction of the high-frequency electric part. The high-dielectric-constant and low-dielectric-loss-tangent insulating layer is suitable for the formation of capacitors, resonant circuit inductors, filters, antennas, and the like.

The high-dielectric-constant insulator used for the present invention is ceramic particles or insulated metal particles. Specific examples of the high-dielectric-constant insulator include silica, alumina, zirconia, and ceramics particles, for example, MgSiO₄, Al₂O₃, MgTiO₃, ZnTiO₃, ZnTiO₄, TiO₂, CaTiO₃, SrTiO₃, SrZrO₃, BaTi₂O₅, BaTi₄O₉, Ba₂Ti O₂₀, Ba(Ti, Sn)₉O₂₀, ZrTiO₄, (Zr, Sn)TiO₄, BaNd₂Ti₅O₁₄, BaSmTiO₁₄, Bi₂O₃—BaO—Nd₂O₃—TiO₂, La₂Ti₂O₇, BaTiO₃, Ba(Ti, Zr)O₃, and (Ba, Sr)TiO₃.

Examples of the insulated metal particles include, for example, gold, silver, palladium, copper, nickel, iron, cobalt, zinc, Mn—Mg—Zn, Ni—Zn, Mn—Zn, carbonyl iron, Fe—Si, Fe—Al—Si, and Fe—Ni. The high-dielectric-constant insulator particles are produced by fragmentation, granulation, or an atomizing and heat decomposing method of atomizing and thermally treating a heat decomposable metal compound to manufacture metal particulates (JP-B-63-31522, JP-A-6-172802, and JP-A-6-279816). The atomizing and heat decomposing method mixes a metal compound as a starting material, for example, carboxylate, phosphate, or sulfate, with boric acid, silic acid, or phosphoric acid, which reacts with formed metal to become ceramics, or any of various metal salts that are oxidized to become ceramics, and subjects the mixture to an atomizing and heat decomposing process. This allows the formation of metal particles having an insulating layer on their surface. The high-dielectric-constant insulator preferably has an average particle size of 0.2 to 100 μm and more preferably 0.2 to 60 μm in terms of the strength and insulating reliability of the insulating layer. Too small a particle size makes it difficult to knead the resin composition. Too large a particle size results in nonuniform dispersion, which may induce dielectric breakdown and degrade insulating reliability. The high-dielectric-constant particles may be shaped like spheres, fragments, or whiskers. The present invention will be described below in detail with reference to examples and comparative examples.

### EXAMPLE 1

### Synthesis of Copolymer I

First, 0.040 g (0.38 mmol) of copper chloride (I), 150 ml of toluene, and 100 ml (1.24 mol) of pyridine were poured into a double-port flask with a stirrer placed inside and stirred in an oxygen atmosphere of 50 ml/min at 500 to 800 rpm. Then, 5.26 g (28.5 mmol) of 2,6-dimethylphenol and 0.23 g (1.5 mmol) of 2-aryl-6-methylphenol were added to the mixture, which was then stirred in the oxygen atmosphere 25° C. for 90 minutes. After reaction ended, the mixture was precipitated in a very excessive amount of hydrochloric acid/methanol and washed in methanol several times. The mixture was dissolved into toluene, and insoluble components were filtered from the mixture. The mixture was dissolved into toluene again, reprecipitated in a very excessive amount of hydrochloric acid/methanol. The mixture was then washed in methanol several times and then dried in a vacuum at 110° C. for 6 hours to obtain a white solid (Mn=24,000, Mw/Mn=2.2).

### EXAMPLE 2

### Synthesis of Copolymer 2

First, 0.040 g (0.38 mmol) of copper chloride (I), 150 ml of toluene, and 100 ml (1.24 mol) of pyridine were poured into a double-port flask with a stirrer placed inside and stirred in an oxygen atmosphere of 50 ml/min at 500 to 800 rpm. Then, 4.98 g (27.0 mmol) of 2,6-dimethylphenol and 0.45 g (3.0 mmol) of 2-aryl-6-methylphenol were added to the mixture, which was then stirred in the oxygen atmosphere at 25° C. for 90 minutes. After reaction ended, the mixture was precipitated in a very excessive amount of hydrochloric acid/methanol and washed in methanol several times. The mixture was dissolved into toluene, and insoluble components were filtered from the mixture. The mixture was dissolved into toluene again, reprecipitated in a very excessive amount of hydrochloric acid/methanol. The mixture was then washed in methanol several times and then dried in a vacuum at 110° C. for 6 hours to obtain a white solid (Mn=24,000, Mw/Mn=2.3).

### EXAMPLE 3

### Synthesis of Copolymer 3

First, 0.040 g (0.38 mmol) of copper chloride (I), 150 ml of toluene, and 100 ml (1.24 mol) of pyridine were poured into a double-port flask with a stirrer placed inside and stirred in an oxygen atmosphere of 50 ml/min at 500 to 800 rpm. Then, 4.43 g (24.0 mmol) of 2,6-dimethylphenol and 0.90 g (6.0 mmol) of 2-aryl-6-methylphenol were added to the mixture, which was then stirred in the oxygen atmosphere at 25° C. for 90 minutes. After reaction ended, the mixture was precipitated in a very excessive amount of hydrochloric acid/methanol and washed in methanol several times. The mixture was dissolved into toluene, and insoluble components were filtered from the mixture. The mixture was dissolved into toluene again, reprecipitated in a very excessive amount of hydrochloric acid/methanol. The mixture was then washed in methanol several times and then dried in a vacuum at 110° C. for 6 hours to obtain a white solid (Mn=23,000, Mw/Mn=2.3).

### EXAMPLE 4

### Synthesis of Copolymer 4

First, 0.040 g (0.38 mmol) of copper chloride (I), 150 ml of toluene, and 100 ml (1.24 mol) of pyridine were poured into a double-port flask with a stirrer placed inside and stirred in an oxygen atmosphere of 50 ml/min at 500 to 800 rpm. Then, 4.98 g (27.0 mmol) of 2,6-dimethylphenol and 0.675 g (3.0 mmol) of 2,6-bis(3-methyl-2-butenyl) were added to the mixture, which was then stirred in the oxygen atmosphere at 25° C. for 120 minutes. After reaction ended, the mixture was precipitated in a very excessive amount of hydrochloric acid/methanol and washed in methanol several times. The mixture was dissolved into toluene, and insoluble components were filtered from the mixture. The mixture was dissolved into toluene again, reprecipitated in a very excessive amount of hydrochloric acid/methanol. The mixture was then washed in methanol several times and then dried in a vacuum at 110° C. for 6 hours to obtain a white solid (Mn=27,000, Mw/Mn=2.5).

### COMPARATIVE EXAMPLE 1

A 2,6-dimetyl-1,4-phenylenether polymer commercially available from Aldrich was used (Mn=27,000, Mw/Mn=2.7).

### COMPARATIVE EXAMPLE 2

First, 0.040 g (0.38 mmol) of copper chloride (I), 150 ml of toluene, and 10 ml (0.124 mol) of pyridine were poured into a double-port flask with a stirrer placed inside and stirred in an oxygen atmosphere of 50 ml/min at 500 to 800 rpm. Then, 4.98 g (27.0 mmol) of 2,6-dimethylphenol and 0.45 g (3.0 mmol) of 2-aryl-6-methylphenol were added to the mixture, which was then stirred in the oxygen atmosphere at 25° C. for 60 minutes. After reaction ended, the mixture was precipitated in a very excessive amount of hydrochloric acid/methanol and washed in methanol several times. The mixture was dissolved into toluene, and insoluble components were filtered from the mixture. The mixture was dissolved into toluene again, reprecipitated in a very excessive amount of hydrochloric acid/methanol. The mixture was then washed in methanol several times and then dried in a vacuum at 110° C. for 6 hours to obtain a white solid (Mn=36,000, Mw/Mn=42.3).

### Measurements of Relative Dielectric Constant and Dielectric Loss Tangent

The relative dielectric constant and dielectric loss tangent were measured at 10 GHz using a cavity resonance method (8722ES Network Analyzer manufactured by Agilent Technologies and a cavity resonator manufactured by Kanto Electronic Application and Development).

### Glass Transition Temperature

A heat, stress, and strain measuring instrument (TMA/SS:SEIKO EXSTAR6000TMA/SS6100) was used to measure a storage modulus E′ and an elastic loss tan δ. The transition temperature was set at the peak position of tan δ. The measuring temperature increase speed was set at 5° C./min.

### Solder Heat Resistance

In conformity to JIS standard C6481, a 25×25-mm laminate covered with copper on both sides was allowed to float in a solder bath at 260° C. for 120 seconds. The sample was then taken out and checked for swell, peel-off, deformation, and warpage.

To determine hardened resin characteristics, the resin in each of Examples 1 to 4 and Comparative Examples 1 and 2 was pressed using a spacer of thickness 1 mm and molded under heat to obtain a hardened resin plate. For the molding, the pressure was set at 2 MPa and heating was carried out at 260° C./60 min (temperature increase 10° C./min).

To determine board characteristics, 100 g of copolymer in each of Examples 1 to 4 and Comparative Examples 1 and 2 was dissolved into the solvents shown in Table 1 to produce varnish containing 30 wt % of solids and a E glass cloth (manufactured by Nitto Boseki Co., Ltd.; thickness: 50 μm). The solvent was then removed at 120° C. for 10 minutes to obtain a prepreg. Three prepregs obtained were laid on top of one another, and copper foils (manufactured by Nippon Denkai, Ltd.; thickness: 18 μm) were placed on the surfaces of the top and bottom prepregs. The prepregs were pressed and molded under heat to obtain a copper-covered laminate. For the molding, the pressure was set at 2 MPa and heating was carried out at 260° C./60 min (temperature increase 10° C./min).

Table 1 shows the characteristics of the resin compositions, hardened resins, and boards in Examples 1 to 4 and Comparative Examples 1 and 2. The PPE copolymer prepared by the conventional synthesizing method and containing an aryl group in a side chain (Comparative Example 2) suffered a greater dielectric loss than the commercially available PPE resin (Comparative Example 1). However, all the copolymers in accordance with the present invention exhibited better performance than that in Comparative Example 2. In particular, the resins in Examples 1 to 3 exhibited almost the same dielectric loss characteristic as that of the commercially available PPE resin. The resin in Example 4 exhibited a higher glass transition temperature than thermoplastic PPE resins and has proved excellent in heat resistance. Further, all the resins in Examples 1 to 4 solved in toluene in at least 10 wt %.

TABLE 1

| | | | | | | | Comparative | Comparative |
|---|---|---|---|---|---|---|---|---|
| | | | Example 1 | Example 2 | Example 3 | Example 4 | Example 1 | Example 2 |
| Copolymer structure | | | Aryl group 5% | Aryl group 10% | Aryl group 15% | Diisobutenyl | PPE | Aryl group 10% |
| | | | | | group 10% | | | |
| Resin | Glass transition | | 190° C. | 175° C. | 165° C. | 225° C. | 210° C. | 220° C. |
| compo- | temperature | | (thermosetting) | (thermosetting) | (thermosetting) | (thermosetting) | (thermoplastic) | (thermosetting) |
| sition | Electrical | Relative | 2.38 | 2.38 | 2.39 | 2.42 | 2.38 | 2.51 |
| char- | characteristics | dielectric | | | | | | |
| acteristics | @ 10 Ghz | constant | | | | | | |
| | | Dielectric | 0.0022 | 0.0022 | 0.0024 | 0.0027 | 0.0022 | 0.0032 |
| | | loss | | | | | | |
| | | tangent | | | | | | |
| Solvent for board production | | | Toluene | Toluene | Toluene | Toluene | Chloroform | Toluene |
| (room temperature) | | | | | | | | |
| Board | Electrical | Relative | 2.77 | 2.79 | 2.81 | 2.87 | 2.78 | 2.91 |
| charac- | characteristics | dielectric | | | | | | |
| teristics E | @ 10 Ghz | constant | | | | | | |
| glass cloth | | Dielectric | 0.0034 | 0.0034 | 0.0036 | 0.0045 | 0.0034 | 0.0044 |
| | | loss | | | | | | |
| | | tangent | | | | | | |

| | | | | | | |
|---|---|---|---|---|---|---|
| Solder heat resistance | ◯ | ◯ | ◯ | ◯ | X | ◯ |
| 260° C./120 sec | | | | | (Board deformed) | |

As shown in the board characteristic results, the resin in Comparative Example 1 was deformed under heat owing to its thermoplasticity, whereas the resins in Examples 1 to 4 and Comparative Example 2 were not deformed. The resins in Examples 1 to 3 exhibited dielectric loss characteristics equivalent to those of the resin in Comparative Example 1.

A cross linking catalyst (2,5-dimethyl-2,5-(t-butylperoxy)hexene-3 (Perhexene 25B manufactured by NOF CORPORATION) and a cross-linker (1,3,5-triarylisocyanurate (TAIC manufactured by Nippon Kasei Chemical Co., Ltd.)) were added to the resin prepared in Example 2 to obtain a resin composition. The resin composition was pressed at 2 MPa and heated at 260° C./60 min (temperature increase 10° C./min).

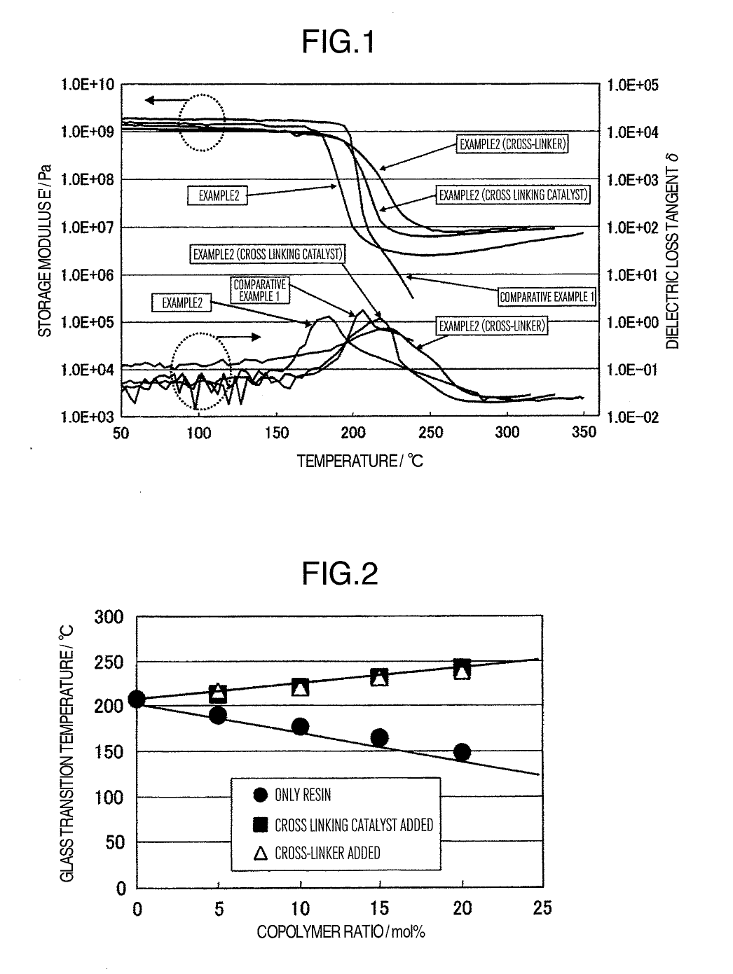

FIG. 1 shows the storage modulus E′ and dielectric loss tangent tanδ of each hardened resin measured using the TMA/SS. Measurements were made for the resin in Example 2, a resin composition obtained by adding 0.1 wt % of cross linking catalyst to the resin in Example 2, and a resin composition obtained by adding 0.1 wt % of cross-linker to the resin in Example 2. The glass transition temperatures of the resin compositions rose more sharply than that of the unitary resin. Further, the storage modulus did not increase at about 300° C. This indicates the further progress of the cross linking reaction. Furthermore, according to the present invention, a small amount of additive promoted the cross linking reaction. This is probably due to the structural specificity of the resin.

FIG. 2 shows the glass transition temperatures Tg of resin compositions formed as in the case of Examples 1 to 3. Molding the resin only by heating resulted in many unchanged portions, the number of which increased consistently with the content of unsaturated bonds, and in a lower glass transition temperature. The formation of the resin into the resin composition promoted the hardening of non-cross-linked portions and increased the resin glass transition temperature above that in Comparative Example 1. Further, the glass transition temperature increased consistently with the amount of unsaturated bonds. Thus, resins with various thermal characteristics were successfully obtained on the basis of the content of unsaturated bonds and the compounding ratio of the resin composition.

Description will be given below of a method for producing a resin with a narrow molecular weight distribution by oxidation coupling polymerization.

### EXAMPLE 5

Examination of Synthesis Conditions for the Copolymer First, 150 ml of toluene and predetermined amounts of copper chloride (I) and pyridine were poured into a double-port flask with a stirrer placed inside and stirred in an oxygen atmosphere of 50 ml/min at 500 to 800 rpm. Then, 4.98 g (27.0 mmol) of 2,6-dimethylphenol and 0.45 g (3.0 mmol) of 2-aryl-6-methylphenol were added to the mixture, which was then stirred in the oxygen atmosphere at 25° C. for 90 minutes. After reaction ended, the mixture was precipitated in a very excessive amount of hydrochloric acid/methanol and washed in methanol several times. The mixture was dissolved into toluene, and insoluble components were filtered from the mixture. The mixture was dissolved into toluene again, reprecipitated in a very excessive amount of hydrochloric acid/methanol. The mixture was then washed in methanol several times and then dried in a vacuum at 110° C. for 6 hours to obtain a white solid.

### Measurements of the Molecular Weight and Molecular Weight Distribution

Measurements were carried out using a gel permeation chromatography (GPC, column: Shodex K-804L (column temperature: 40° C.), a pump: SHIMADZU LC-10AT, a UV detector: SHIMADZU SPD-10A, an eluent: chloroform (flow rate: 1 ml/min), and a standard material: polystyrene).

Table 2 shows copper chloride (I) and the amount of pyridine added and the molar ratios of the monomer to copper chloride (I) and of pyridine to copper chloride (I). The table shows that an increase in monomer ratio lowered the number average molecular weight Mn drastically reduced the molecular weight distribution Mw/Mn. Further, possible secondary reactions were suppressed to increase the yield of the resin.

TABLE 2

| | | | Copper | Monomer | Pyridine | | | |
|---|---|---|---|---|---|---|---|---|
| | Temperature | Time | chloride (I) | ratio⁽¹⁾ | ratio⁽²⁾ | | | |
| Run No. | ° C. | min | mg (mmol) | (molar ratio) | (molar ratio) | Mn | Mw/Mn | Yield % |
| 1 | 25 | 90 | 400 (3.81) | 7.87 | 33 | 36000 | 42.3 | 80.8 |
| 2 | 25 | 90 | 400 (3.81) | 7.87 | 66 | 41000 | 12.1 | 83.1 |
| 3 | 25 | 90 | 400 (3.81) | 7.87 | 330 | 42000 | 8.3 | 87.9 |
| 4 | 25 | 90 | 200 (1.91) | 15.71 | 130 | 28000 | 6.2 | 88.3 |
| 5 | 25 | 90 | 40 (0.38) | 78.95 | 660 | 21000 | 2.4 | 89.7 |
| 6 | 25 | 90 | 40 (0.38) | 78.95 | 3300 | 22000 | 2.2 | 91.1 |

⁽¹⁾Molar ratio of the monomer to copper chloride (I)
⁽²⁾Molar ratio of pyridine to copper chloride (I)

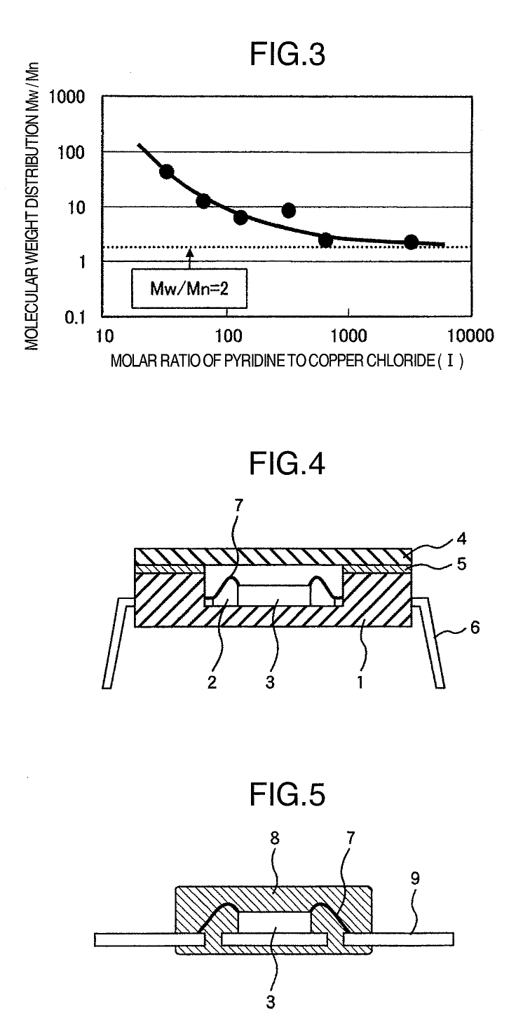

FIG. 3 shows the relationship between the pyridine ratio and the molecular weight distribution. An increase in pyridine ratio narrowed the molecular weight distribution regardless of the amount of copper chloride (I) and the monomer ratio. In particular, when the pyridine ratio was at least 660, Mw/Mn was close to 2, which corresponds to the ideal polymerizing behavior shown by the Flory's theoretical equation (the theoretical equation for the molecular weight distribution of polymer resulting from a condensation polymerization reaction). The oxidation coupling copolymerization in Example 5 is expected to have suppressed possible secondary reactions, promoting C-o coupling, the primary reaction. This is expected to have suppressed the generation of biphenoquinone, a byproduct of C—C coupling. The present invention properly suppressed the growth reaction speed of the resin in addition to possible secondary reactions. The present invention is thus expected to have promoted C—O coupling, oxidation coupling polymerization, while inhibiting branching to unsaturated hydrocarbon groups.

Electronic parts in accordance with the present invention will be described on the basis of the characteristics required for the electronic parts.

### (1) Semiconductor Device

Conventional high-frequency semiconductor devices have been manufactured in hermetic seal packages having an air layer as an insulating layer as shown in FIG. 4 in order to reduce inter-wire electrostatic capacity, which interferes with high frequency operations. The present invention produces a semiconductor device insulated and protected by a low-dielectric-constant, low-dielectric-loss-tangent resin layer, by mixedly dispersing a low-dielectric-constant, low-dielectric-loss-tangent resin composition containing a cross linking component and low-dielectric-constant insulator particles and also containing a high-molecular-weight substance, a fire retardant, a second cross linking component, a releasing agent, or a coloring agent as required, all the components being blended in a predetermined ratio, in an organic solvent or without any solvent, covering a semiconductor chip with the low-dielectric-constant, low-dielectric-loss-tangent resin composition, and hardening the resin composition by drying if necessary. The low-dielectric-constant, low-dielectric-loss-tangent resin composition can be hardened by heating at 120 to 240° C.

FIG. 5 shows an example of a high-frequency semiconductor device in accordance with the present invention. However, the shape of the high-frequency semiconductor device is not particularly limited. The present invention allows an efficient high-frequency semiconductor device with a high transmission speed and a low dielectric loss to be produced using an inexpensive molding method. Transfer pressing, potting, or the like may be used to form a low-dielectric-constant, low-dielectric-loss-tangent insulating layer in accordance with the present invention; the forming method may be appropriately selected depending on the shape of the semiconductor device. The form of the semiconductor device is not particularly limited. For example, the semiconductor device comprises a wiring board on which a tape carrier package and a semiconductor chip are bare-chip-mounted.

### (2) Multilayer Board

A multilayer board in accordance with the present invention exhibits a lower dielectric loss tangent than the conventional thermosetting resin compositions. Consequently, the wiring board using the present cross linking component in the insulating layer suffers a reduced dielectric loss and offers an excellent high-frequency characteristic. Description will be given of a method for producing a multilayer wiring board. According to the present invention, a prepreg or a conductor foil with an insulating layer, serving as a starting material for a multilayer wiring board, is produced by kneading a low-dielectric-loss-tangent resin composition containing a cross-linking component and a high-molecular-weight substance and also containing low- or high-dielectric-constant insulator particles, a fire retardant, a second cross linking component, a coloring agent, or the like as required, all the components being blended in a predetermined ratio, in a solvent to obtain a slurry, coating the slurry on a base such as a glass cloth, a nonwoven cloth, or a conductor foil, and then drying the base.

The prepreg can be used as a core material for a laminate, or a bonding layer and insulating layer for laminates or for a laminate and a conductor foil. The copper foil with the insulating layer is used to form a conductor layer on the surface of the core material by lamination or pressing. The core material in accordance with the present invention is a base that carries and reinforces the copper foil with the insulating layer. Examples of the core material include general-purpose resin plates such as a glass cloth, a nonwoven cloth, a film material, a ceramic board, a glass board, and epoxy, and general-purpose laminates.

The solvent used to form a slurry is preferably the same as that used for the cross linking component, high-molecular-weight substance, fire retardant, or the like which is blended into the resin composition. Examples of the solvent include dimethylformamide, methylethylketone, methylisobutylketone, dioxane, tetrahydrofuran, toluene, and chloroform. Drying conditions (for the B stage) for the prepreg or the conductor foil with the insulating layer are adjusted according to the solvent used and the thickness of the resin layer coated. For example, to form an insulating layer of dry thickness about 50 μm using, for example, toluene, drying may be performed at 80 to 130° C. for 30 to 90 minutes. The preferable thickness of the insulating layer is 50 to 300 μm as required, and is adjusted according to the application and required characteristics (wiring pattern size and DC resistance).

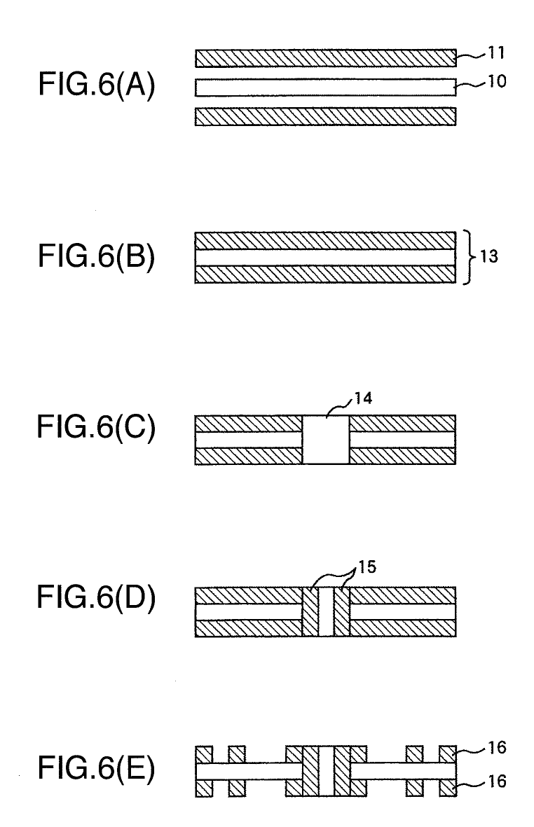

An example of production of a multilayer wiring board is shown below. FIG. 6 shows a first example. As shown in FIG. 6(A), a prepreg 10 and conductor foils 11 having predetermined thicknesses are laid on top of one another. The conductor foil used is selected to offer a high conductivity; the conductor foil is optionally selected from copper, silver, copper, aluminum, and the like. The conductor foil has a significantly uneven surface in order to adhere firmly to the prepreg or has a relatively smooth surface in order to further improve the high-frequency characteristic. The thickness of the conductor foil is preferably about 9 to 35 μm in terms of etching processability.

As shown in FIG. 6(B), the prepreg and conductor foils are bonded and hardened by heating them under pressure. A laminate 13 having conductor layers on its surfaces is thus obtained. The prepreg and conductor foils are preferably heated at 120 to 240° C. under a pressure of 1.0 to 10 MPa for 1 to 3 houses. The temperature and pressure for the pressing may be varied step by step without the above ranges. The insulating layer in the laminate obtained in accordance with the present invention has a very low dielectric loss tangent and thus exhibits an excellent high-frequency transmission characteristic.

Description will be given of an example in which double-side wiring board is produced. As shown in FIG. 6(C), a through-hole 14 is formed in the already produced laminate at a predetermined position by means of drilling. As shown in FIG. 6(D), a plating film 15 is formed in the through-hole by plating to electrically connect the front and back conductor foils together. As shown in FIG. 6(E), the conductor foils on the opposite surfaces are patterned to form conductor wires 16.

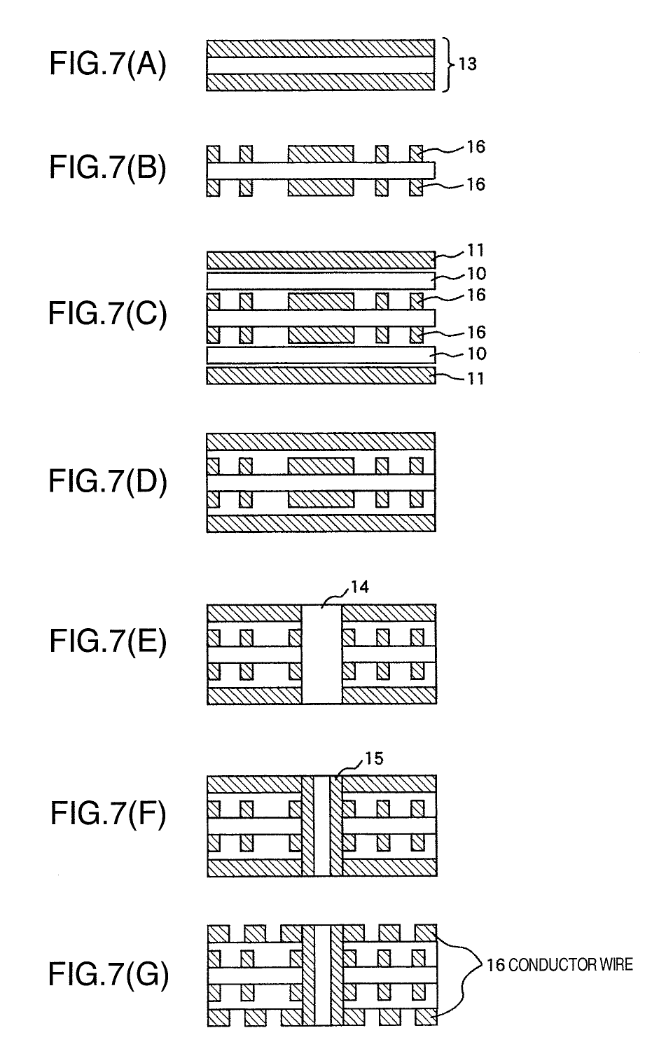

Now, description will be given of an example in which a multilayer wiring board is produced. As shown in FIG. 7(A), a prepreg and conductor foils having predetermined thicknesses are used to produce a laminate 13. As shown in FIG. 7(B), conductor wires 16 are formed on the opposite surfaces of the laminate. As shown in FIG. 7(C), prepregs 10 and conductor foils 11 having predetermined thicknesses are laid on the patterned laminate. As shown in FIG. 7(D), the laminate is heated under pressure to form conductor foils in the outer layers. As shown in FIG. 7(E), a through-hole 14 is formed in the laminate at a predetermined position by means of drilling. As shown in FIG. 7(F), a plating film 15 is formed in the through-hole to electrically connect layers together. As shown in FIG. 7(G), the conductor foils in the outer layers are patterned to form conductor wires 16.

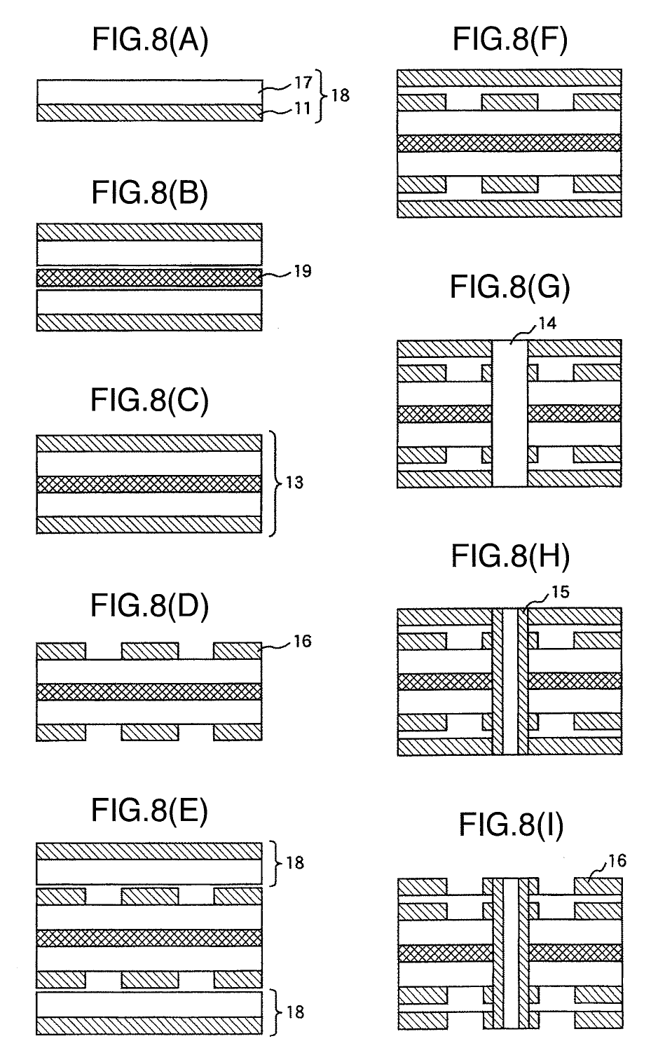

An example in which a multilayer wiring board is produced using a copper foil with an insulating layer is shown below. As shown in FIG. 8(A), varnish of the resin component in accordance with the present invention is applied to the conductor foil 11 and dried to form a conductor foil 18 having an unhardened insulating layer 17. As shown in FIG. 8(B), the conductor foils 18 are laid on a lead terminal 19. As shown in FIG. 8(C), the lead terminal 19 and the conductor foils 18 with the insulating layers are bonded together by pressing to form a laminate 13. Pre-subjecting the surface of the core material to a coupling or roughing process improves the adhesion between the core material and the insulating layer. As shown in FIG. 8(D) the conductor foils 18 in the laminate 13 are patterned to form conductor wires 16. As shown in FIG. 8(E), conductor foils with insulator layers are laid on the laminate 13 having the wires formed thereon. As shown in FIG. 8(F), the laminate 13 and the conductor foils with the insulating layers are bonded together by pressing. As shown in FIG. 8(G), a through-hole 14 is formed at a predetermined position. As shown in FIG. 8(H), a plating film 15 is formed in the through-hole 14. As shown in FIG. 8(I), the conductor foils 11 in the outer layers are patterned to form conductor wires 16.

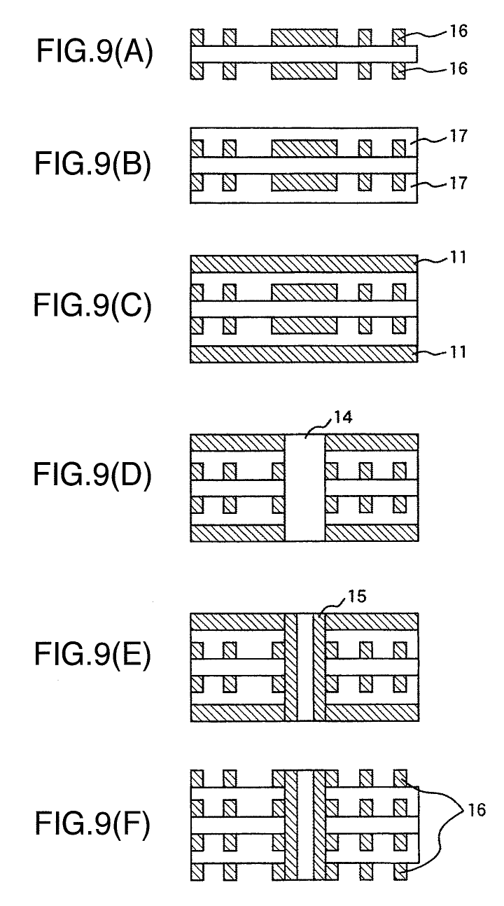

An example in which a multilayer wiring board is produced by screen printing is shown below. As shown in FIG. 9(A), the conductor foils in the laminate 13 are patterned to form conductor wires 16. As shown in FIG. 9(B), varnish of the resin composition in accordance with the present invention is applied to the laminate by screen printing and dried to form insulating layers 17. At this time, a resin composition offering a different dielectric constant can be applied to a part of the laminate by screen printing to form an insulating layer with a different dielectric constant which is flush with the insulating layer 17. As shown in FIG. 9(C), the conductor foil 11 is laid on each of the insulating layers 17 and bonded to it by pressing. As shown in FIG. 9(D), a through-hole 14 is formed at a predetermined position. As shown in FIG. 9(E), a plating film 15 is formed in the through-hole. As shown in FIG. 9(F), the conductor films 11 in the outer layers are patterned to form conductor wires 16.

The present invention is not limited to the above examples and enables various wiring boards to be formed. For example, the present invention enables a laminate with very many layers to be formed by stacking a plurality of laminates with wires formed thereon on one another at a time via prepregs. The present invention also enables the formation of a buildup multilayer wiring board having layers electrically connected together through blind via holes formed by laser or dry etching. For the production of a multilayer wiring board, the dielectric constant and dielectric loss tangent of each insulating layer can be optionally selected. Insulating layers with different characteristics can be mixedly combined together according to the purpose of the wiring board such as a reduction in dielectric loss, an increase in transmission speed, a size reduction, and a cost reduction.

By using the low-dielectric-loss-tangent resin composition in accordance with the present invention as an insulating layer, it is possible to provide a high-frequency electronic part which suffers a reduced dielectric loss and which offers an excellent high-frequency characteristic. Further, by incorporating device patterns into conductor wires by the above methods for producing a multilayer wiring board, it is possible to provide a high-performance high-frequency electronic part having various functions. For example, a multilayer wiring board can be produced which has at least one of a capacitor function, an inductor function, and an antenna function.

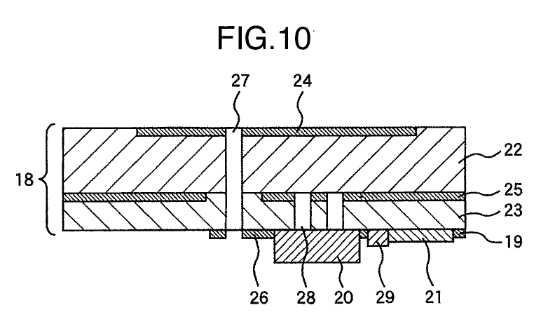

An example in which the multilayer wiring board is applied to an antenna is shown below. FIG. 10 is a sectional view showing the sectional structure of essential part of an antenna element-integrated high-frequency circuit module. The present example is an antenna element-integrated high-frequency circuit module that transmits and receives circularly polarized waves in a 5-GHz frequency band. As shown in FIG. 10, the antenna element-integrated high-frequency circuit module in the present example is composed of a rectangular substrate 18, a high-frequency circuit module 20 constructed using an MMIC, and discrete parts 21. The high-frequency circuit module 20 is composed of a package produced using a multilayer board made of glass ceramics (not shown) and MMIC chips produced using GaAs semiconductors and laminated to the package. The MMIC chips constitute a switch, a low-noise amplifier, a power amplifier, a mixer, a multiplier, and the like. Wires connecting these MMIC chips together are provided in the glass ceramic package. The MMIC chips are connected, by wire bonding, to the wires provided in the package.

A bandpass filter, a phase lock loop (PLL) module, and a crystal oscillator are composed of the discrete parts 21. The board 18 is formed of three conductor layers comprising copper foils and two dielectric layers (22 and 23). The conductor layers are used an antenna element 24, a ground electrode 25, and wires 26 in this order from top to bottom. At the crossing between the wires 26, the wires 26 are connected together via a jumper wire 29. The antenna element-integrated high-frequency circuit module is connected to an external device via an external connection terminal 19.

A plurality of the wires 26 are formed in the third conductor layer, including a wire through which power is supplied to the high-frequency circuit module 20, a wire that connects the high-frequency module 20 to the discrete parts 21 and the external circuit, and a wire that connects the antenna element 24 and the high-frequency circuit module 20 together. The antenna element 24 and some wires 26 are connected together via a vie hole 27. A part of the pattern formed in the same conductor layer in which the wire 26 is formed is electrically connected to the ground electrode 25 via holes 28 and is configured to have the same potential as that of the ground electrode 25.

In the present example, the dielectric layers 22 and 23, constituting the board 18, have different thicknesses. The thickness of the dielectric layer 22 is appropriately changed depending on the band or gain required for the antenna. The thickness of the dielectric layer 23 is also appropriately changed so that the thickness of the entire antenna element-integrated high-frequency circuit module or the width of the wires 26 has a desired value. The dielectric layers used in the present example are made of the low dielectric loss resin in accordance with the present invention. The dielectric layers thus offer a low dielectric loss tangent to enable a reduction in transmission loss.

In the present example, the board 18 is composed of the three conductor layers and the two dielectric layers. The electrical characteristics of the dielectric layer 22 may be different from those of the dielectric layer 23. In particular, the dielectric layers 22 and 23 may have different relative dielectric constants; the dielectric layer 23 may effectively have a greater relative dielectric constant.

In the present example, if a copper foil is laid on the dielectric layer 23 to form a wire for a quarter wavelength, the length of the wire varies with the relative dielectric constant of the dielectric layer 23; the length of the wiring pattern decreases with increasing relative dielectric constant. Accordingly, the present example uses the dielectric layer 23 with the larger relative dielectric constant to reduce the length of the wiring pattern for the quarter wavelength and thus the size of the antenna element-integrated high-frequency circuit module. On the other hand, the antenna generally offers better electrical characteristics when the dielectric layer 22 has a smaller relative dielectric constant. Accordingly, the dielectric layer 22 has a smaller relative dielectric constant than the dielectric layer 23.

Thus, in the present embodiment, the board 18 is composed of the dielectric layers 22 and 23, having the different relative dielectric constants. This makes it possible to provide a small antenna-element-integrated high-frequency circuit module in which the antenna offers proper characteristics. If the dielectric layers have different dielectric constants, the porous polyimide produced in Examples 1 to 3 is used as the low-dielectric-constant material. This enables a reduction in transmission loss. Further, high-dielectric oxide particles may be filled into the porous layer to form a high-dielectric layer. With the porous substance, the dielectric constant of the dielectric layer can be freely manipulated by controlling the type and amount of the filling material in the porous layer. This makes it possible to simplify the design of the circuit board.

Examples of electronic parts produced by combining the present invention with other electronic part materials are shown below. Table 3 shows the resin compositions used for the present invention and their characteristics. The composition ratios in the table indicate weight ratios. Description will be given of the names of reagents, a method for preparing varnish, and a method for evaluating the performance required for the resin to function as an electronic material, which are used in the examples. The copolymer synthesized under the conditions in Example 2 has been described as an example of a high-molecular-weight substance. This does not limit the scope of the present invention.

### Fire Retardant

HISHIGARD(R): manufactured by Nippon Chemical Industrial CO., LTD., red phosphorous particles (HISHIGARD TP-A10), average particle size: 20 μm Low-Dielectric-Constant Insulator
Z-36: Tokai Kogyo CO., LTD., borosilicate glass balloons (average particle size: 56 μm) High-Dielectric-Constant Insulator

### Ba—Ti: barium titanate-containing inorganic filler of dielectric constant 70 at 1 GHz, density 5.5 g/cm³ and average particle size 1.5 μm

### Method for Preparing Varnish

Varnish of a resin component was prepared by mixedly dispersing a predetermined amount of the resin component in toluene.

### Measurements of the Relative Dielectric Constant and Dielectric Loss Tangent

Measurements were made at 10 GHz by the cavity resonance method (8722ES Network Analyzer manufactured by Agilent Technologies and a cavity resonator manufactured by Kanto Electronic Application and Development).

### Inflammability

Inflammability was evaluated in conformity to the UL-94 standards using a sample of size 70×3×1.5 mm.

### EXAMPLE 6

Example 6 is a resin component obtained by adding red phosphorous particles to Example 2 as a fire retardant. The addition of the fire retardant makes the resin composition inflammable to improve the safety of electric parts.

### EXAMPLES 7 AND 8

Examples 7 and 8 correspond to Example 2 to which glass balloons (Z36) were added as a low-dielectric-constant insulator. Increasing the amount of Z36 added reduced the dielectric constant from 2.8 to 2.0. Electric parts using the present resin composition in the insulating layer have reduced dielectric losses and enable faster transmissions.

### EXAMPLES 9 AND 10

Examples 9 and 10 correspond to Example 2 to which ceramic particles (Ba—Ti) were added as a high-dielectric-constant insulator. Increasing the content of Ba—Ti increased the dielectric constant from 2.8 to 12.1. The use of the present resin composition in the insulating layer provides small high-frequency electric parts having reduced dielectric losses.

### EXAMPLE 11

Example 11 is an aqueous resin composition containing the low-dielectric-loss resin shown in Example 2 and exhibiting a low dielectric constant and a low dielectric loss tangent when hardened. The aqueous resin composition can be cast at room temperature and low pressure. Owing to their low dielectric constants and low dielectric loss tangents, high-frequency electronic parts having insulating layers made of the resin composition in accordance with the present invention enable high-speed transmissions and suffer reduced dielectric losses.

TABLE 3

| | | Example 6 | Example 7 | Example 8 | Example 9 | Example 10 | Example 11 |
|---|---|---|---|---|---|---|---|
| 2-aryl-6-methylphenol | | 10% | 10% | 10% | 10% | 10% | 10% |
| copolymer ratio | | | | | | | |
| HISHIGARD | | 5% | 5% | 5% | 5% | 5% | 0% |
| Z36 | | 0% | 10% | 20% | 0% | 0% | 10% |
| Ceramic particles | | 0% | 0% | 0% | 100% | 200% | 0% |
| Electrical | Relative | 2.67 | 2.31 | 2.02 | 5.73 | 11.23 | 2.10 |
| characteristics | dielectric | | | | | | |
| @10 Ghz | constant | | | | | | |
| | Dielectric | 0.0035 | 0.0032 | 0.0028 | 0.0046 | 0.0052 | 0.0026 |
| | loss tangent | | | | | | |

| | | | | | | |
|---|---|---|---|---|---|---|
| Inflammability | V0 | V0 | V0 | V0 | V0 | None |

| | | | | |
|---|---|---|---|---|
| Remarks | Fire | Low ε, low tan δ | High ε, low tan δ | For potting |
| | retardant | | | |
| | added | | | |

It should be further understood by those skilled in the art that although the foregoing description has been made on embodiments of the invention, the invention is not limited thereto and various changes and modifications may be made without departing from the spirit of the invention and the scope of the appended claims.

1. A thermosetting low dielectric loss resin which is a random copolymer consisting of repeating units expressed by the following Formula: 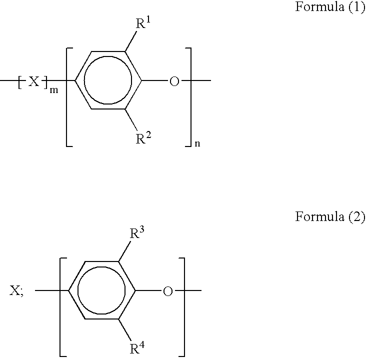
where X denotes a repeating unit expressed by Formula 2, R¹ and R² denote hydrocarbon groups with a carbon number of 1, R³ denotes a functional group containing an unsaturated hydrocarbon with a carbon number of 2 to 9, R⁴ denotes a functional group containing at least one of a saturated hydrocarbon, an unsaturated hydrocarbon, and an aromatic hydrocarbon, and m and n denote integers of at least 2 which indicate the degrees of polymerization, wherein the copolymer has a molecular weight distribution of less than 10.

2. The low dielectric loss resin according to claim 1, wherein a glass transition temperature before hardening is at most 210° C.

3. The low dielectric loss resin according to claim 1, wherein the resin or the hardened resin has a dielectric loss tangent of at most 0.003.

4. The low dielectric loss resin according to claim 1, wherein at least 10 wt % of the resin is soluble in a non-halogen-containing solvent with a boiling point of at most 150° C. at room temperature.

5. A resin composition containing the low dielectric loss resin according to claim 1, wherein the resin composition contains 0.01 to 5 wt % of radical salt or peroxide with respect to the weight of the copolymer, as a cross linking catalyst.

6. A resin composition containing the low dielectric loss resin according to claim 1, wherein the resin composition contains 0.01 to 5 wt % of cross-linker.

7. A resin composition containing the low dielectric loss resin according to claim 5, wherein the resin composition contains an organic solvent and the copolymer dissolved into the organic solvent by at least 10 wt %.

8. The resin composition according to claim 7, wherein the organic solvent is a non-halogen-containing solvent with a boiling point of at most 150° C.

9. A resin composition containing the low dielectric loss resin according to claim 1 and a fire retardant.

10. A resin composition containing at least one type of low dielectric constant layer selected from low dielectric loss resin particles of average particle size 1 to 100 μm, empty resin particles, empty glass balloons, and a void, as well as the low dielectric loss resin according to claim 1.

11. A resin composition containing ceramic particles as a high dielectric constant insulator and the low dielectric loss resin according to claim 1.

12. A hardened low dielectric loss resin wherein some or all of unsaturated bonds in the low dielectric loss resin according to claim 1 are cross-linked.

13. A hardened low dielectric loss resin composition wherein some or all of unsaturated bonds in the resin composition containing the low dielectric loss resin according to claim 1 are cross-linked.

14. An electronic part containing the hardened low dielectric loss resin or low dielectric loss resin composition according to claim 12.

15. A multilayer wiring board potting agent consisting of the low dielectric loss resin or resin composition according to claim 1.

16. A multilayer wiring board prepreg manufactured using the resin composition according to claim 1.

17. A multilayer wiring board manufactured using the prepreg according to claim 16.

18. A high-frequency antenna manufactured using the prepreg according to claim 16.

19. A method for manufacturing a low dielectric loss resin, the method comprising manufacturing a random copolymer having a molecular weight distribution of less than 10 by subjecting, to an oxidation coupling polymerization reaction, a compound consisting of repeating units expressed by Formula (1): 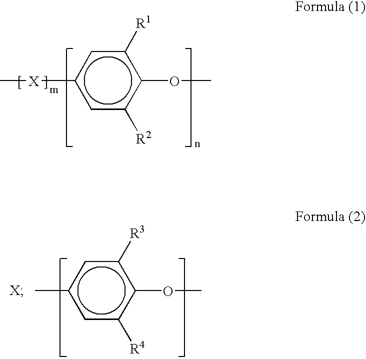
where X denotes a repeating unit expressed by Formula 2, R¹ and R² denote hydrocarbon groups with a carbon number of 1, R³ denotes a functional group containing an unsaturated hydrocarbon with a carbon number of 2 to 9, R⁴ denotes a functional group containing at least one of a saturated hydrocarbon, an unsaturated hydrocarbon, and an aromatic hydrocarbon, and m and n denote integers of at least 2 which indicate the degrees of polymerization.

20. The method for manufacturing a low dielectric loss resin according to claim 19, wherein polymerization is carried out with a molar ratio of a monomer to metal atoms in a polymerization catalyst set to at least 60.

21. The method for manufacturing a low dielectric loss resin according to claim 19, wherein polymerization is carried out with a molar ratio of an amine ligand to metal atoms in a polymerization catalyst set to at least 600.

22. The method for manufacturing a low dielectric loss resin according to claim 19, wherein polymerization is carried out using copper chloride (I) as the metal atoms in the polymerization catalyst and pyridine as the amine ligand.
